(19) United States
(12) Patent Application Publication
(10) Pub. No.: US 2016/0179069 A1
(43) Pub. Date: Jun. 23, 2016

(54) CONTROLLING A BUILDING MANAGEMENT SYSTEM

(71) Applicant: Honeywell International Inc., Morristown, NJ (US)

(72) Inventors: Himanshu Khurana, Plymouth, MN (US); Datta Godbole, Plymouth, MN (US); Sanjay Roy, Plymouth, MN (US); Greg Bernhardt, Hopkins, MN (US)

(21) Appl. No.: 14/974,677

(22) Filed: Dec. 18, 2015

Related U.S. Application Data
(60) Provisional application No. 62/093,531, filed on Dec. 18, 2014.

(51) Int. Cl. G05B 15/02; H04L 12/28

(52) U.S. Cl. CPC G05B 15/02; H04L 12/2816

(57) ABSTRACT

Devices, methods, and systems for controlling a building management system are described herein. One method includes authenticating a user for access to a plurality of building management system (BMS) applications. The authentication can include determining an identity of the user, determining access rights of the user, and determining a location of the user. The method can include receiving building data from the user associated with at least one of the number of BMS applications that changes a building parameter. The method can include changing the building parameter based on the identity, the access rights, and the location of the user and the received building data

### PRIORITY INFORMATION

This application is a Non-Provisional of U.S. Provisional Application No. 62/093,531, filed Dec. 18, 2014, the contents of which are incorporated herein by reference.

### TECHNICAL FIELD

The present disclosure relates to devices, methods, and systems for controlling a building management system.

### BACKGROUND

Building information modeling (BIM) can refer to the generation and/or management of data associated with a building (e.g., data associated with the components, equipment, and/or properties of the building). For example, BIM data can include architectural, mechanical, electrical, plumbing, sanitary, fire, and/or geometrical information associated with a building.

BIM data associated with a building can be used to generate a user interface for a building management system for the building, which can be displayed to a user (e.g., operator) and used to monitor and/or control the building. For example, the user (e.g., operator) of a building management system can check and/or set the state of a control component(s), equipment, device(s), network (s) area(s), and/or space(s) of the building using the user interface of the building management system.

### BRIEF DESCRIPTION OF THE DRAWINGS

FIG. 1 illustrates an example system for controlling a building management system in accordance with one or more embodiments of the present disclosure.

FIG. 2 illustrates an example device for controlling a building management system in accordance with one or more embodiments of the present disclosure.

FIG. 3 illustrates an example method for controlling a building management system in accordance with one or more embodiments of the present disclosure.

### DETAILED DESCRIPTION

Devices, methods, and systems for controlling a building management system (BMS) are described herein. For example, one or more embodiments can include authenticating a user for access to a number (e.g., a plurality) of building management system applications. The authentication can include determining an identity of the user, determining access rights of the user, and determining a location of the user. One or more embodiments can include receiving information from the user associated with at least one of the number of applications.

Embodiments of the present disclosure can decrease the amount of time and/or computing resources needed to be authenticated for each user to access a BMS system. For example, a number (e.g., a plurality) of applications of a BMS system can be accessed by a user at a single location with a single authentication procedure. Further, the number of applications can be used by the user to control a number of aspects of the BMS system.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

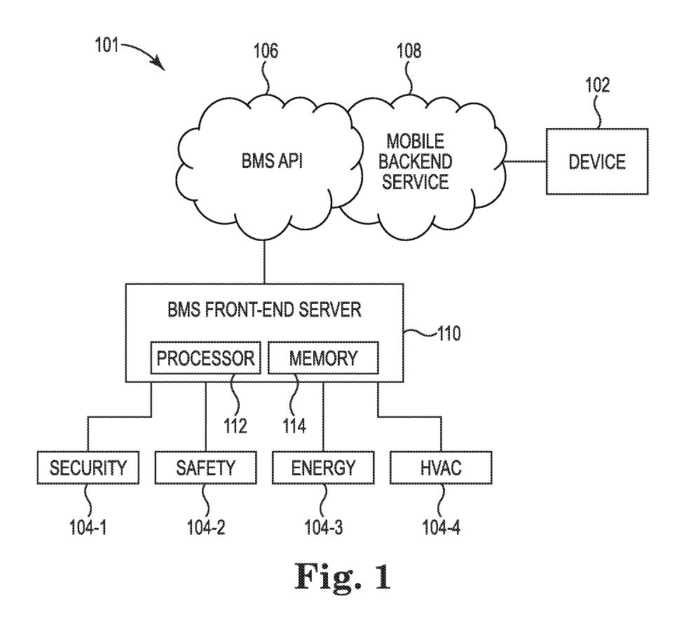

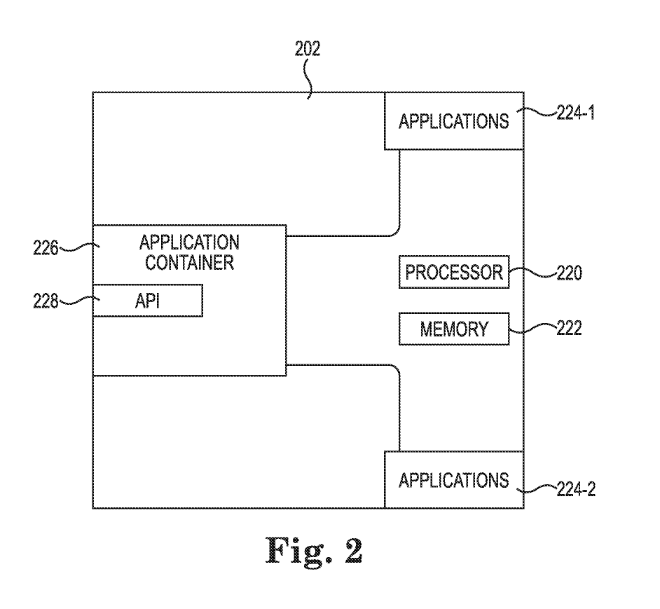

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of buildings” can refer to one or more buildings.

FIG. 1 illustrates a system 101 for controlling a building management system (e.g., a system used to control a building by monitoring, authenticating access, gathering data, changing environments, etc.) in accordance with one or more embodiments of the present disclosure. Controlling the building management system (BMS) can include, for example, authenticating a user for access to a number of building management system applications by determining the user's identity, access rights, and location. The access can be remotely performed using a wireless device and the access can be to a number of locations of the building, including locations that the user is not in proximity to or within. Controlling the BMS can include receiving information from the user associated with at least one of a number of applications associated with the BMS.

As shown in FIG. 1, the system 101 can include a device 102. The device 102 can be, for example, a laptop computer, desktop computer, or mobile device (e.g., smart phone, tablet, PDA, internet interface device, digital device, etc.), among other types of computing devices. In some embodiments, the device 102 can be a part of system 101 and in other embodiments the device can be in communication with system 101 (in which case the system includes the components of FIG. 1 except the device 102). While a single device 102 is shown, embodiments are not so limited.

A number of devices (e.g., device 102) can be connected to and/or in communication with a mobile backend service 108. The mobile backend service 108 can be scalable (e.g., flexible, changeable, dynamic, etc.) and change based on a changing parameter within the BMS system. A BMS building parameter can include at least one of a building access parameter (e.g., level of access rights to the building), a building security parameter (e.g., level of security of a building), a building environment parameter (e.g., related to temperature, pressure, air flow, etc.), a building operations parameter (e.g., operations of the building), and a building safety parameter (e.g., safety regulations and safety measures used by the building).

The mobile backend service 108 can be in communication with an Application Program Interface (API), such as BMS API 106, as illustrated in FIG. 1. The BMS API 106 and the mobile backend service 108 can comprise a private and/or public network (e.g., a public and/or private cloud). For instance, the private/public network can include a wide area network (WAN) such as the Internet, a local area network (LAN), a personal area network (PAN), a campus area network (CAN), or metropolitan area network (MAN), among other types of networks.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network.

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

A user of the device 102 can interact with a server (e.g., a BMS Front End Server) 110 through the BMS API 106. The BMS API 106 can provide (e.g., for display and/or presenting) to the user of the device 102. For instance, in some embodiments, the BMS API 106 can provide graphical user interface (GUI) information that can include information to be displayed (e.g., on a screen) provided to and/or received from the user of the device 102. The information can be displayed, for instance, on a touch-screen (e.g., the GUI can include touch-screen capabilities through a GUI on the device 102). Embodiments of the present disclosure, however, are not limited to a particular type(s) of user interface.

The BMS API 106 can allow a number of users to access a number of applications (e.g., applications 224-1 and 224-2 described in connection with FIG. 2) through a device 102 in communication with a BMS system. The BMS API 106 can gather BMS information from the number of users based on selections made by the number of users on the number of applications. For example, a user tasked with inputting information related to how the building is functioning or monitoring parameters of the building (e.g., temperature, air flow, etc.) can enter information into the device 102 to notify the BMS system. The BMS Front End Server 110 can gather this information from the BMS API 106 and analyze the gathered information to determine whether a BMS parameter has changed or is being requested by the user to be changed.

The building data can be gathered from a number (e.g., a plurality) of users to determine a larger preference (e.g., poll the number of users). For example, a request can be sent to the number of users to indicate whether each of the number of users are hot or cold, warm or cool, etc. A preference of temperature can be requested from each of the number of users. The determination of whether to increase or decrease the temperature of the location can be determined based on data received from the number of users pertaining to their preference. A request can be sent to indicate a particular temperature for the location and an average temperature, mean temperature, median temperature, or a number of group-based temperature outcomes can be determined and the temperature can be changed to one of these temperatures.

The building data can be gathered from a number (e.g., a plurality) of users to indicate whether each of the users are “safe” and/or “in danger.” For example, during or immediately following a particular event (e.g., an earthquake, a fire, a natural disaster, an unsafe incident, etc.) a request can be sent to each of the number of users to indicate whether the number of users are safe and/or in danger in relation to that event. A number of indications can be provided for a response. For example, indications can include safe, protected, in a safe location, evacuated, still inside but safe, still inside and in danger, etc. The group data (e.g., social data) can be returned by the number of users to the Front End Server 110 and the group data can be analyzed and/or used to determine how to change a particular building parameter.

As shown in FIG. 1, the BMS Front End Server 110 can include a processor 112 and memory 114. The memory can be any type of storage medium that can be accessed by the processor 112 to perform various examples of the present disclosure. For example, memory 114 can be a non-transitory compute readable medium having computer readable instructions (e.g., computer program instructions) stored thereon that are executable by processor 112 to perform various examples of the present disclosure. That is processor 112 can execute the executable instructions stored in memory 114 to perform various examples of the present disclosure.

Memory 114 can be volatile or nonvolatile memory. Memory 114 can also be removable (e.g., portable) memory, or non-removable (e.g., internal) memory. For example, memory 114 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 114 is illustrated as being located in the BMS Front End Server 110, embodiments of the present disclosure are not so limited. For example, memory 114 can also be located internal to another computing resource (e.g., enabling computer readable instructions to be downloaded over the Internet or another wired or wireless connection).

The BMS Front End Server 110 can be in communication with a number of BMS systems. The number of BMS systems can include, for example, a security system 104-1, a safety system 104-2, an energy system 104-3, and a Heating/Ventilation/Air Conditioning (HVAC) system 104-4. The number of BMS systems can be associated with at least one of tenants, visitors, safety, energy, environment, building operations, and facility management. However, the number of BMS systems are not limited to those listed and are provided as examples.

The security system 104-1 can control security related issues for a building of the BMS. For example, information from a user of device 102 can provide security information so that the BMS can verify the user's identity and allow the user to access the building.

The safety system 104-2 can control safety related issues for the building of the BMS. For example, BMS information from at least one of the BMS system and/or the user can control safety measures such as air purification, smoke monitoring, temperature monitoring, etc. to insure the building is safe.

The energy system 104-3 can control energy related issues for the building. For example, energy usage by a number of users (e.g., a user of device 102) can be managed and/or monitored based on energy information received from the number of users.

The HVAC system 104-4 can control HVAC related issues for the building of the BMS. For example, a user's preference (e.g., a user of device 102) can determine heating and/or cooling of a particular room that the user is going to enter or is already occupying.

FIG. 2 illustrates an example device 202 for controlling a building management system in accordance with one or more embodiments of the present disclosure. The device 202 (e.g., device 102 in FIG. 1) can include a processor 220 and memory 222, as shown in FIG. 1. Memory 222 and processor 220 can be analogous to memory 114 and processor 112 previously described in connection with FIG. 1.

Device 202 can include a number of applications 224-1, 224-2. The number of applications 224-1, 224-2 can be associated with at least one of room comfort control, mobile access control, visitor management, location based services, and facility management. While the list of possible applications is provided as an example, applications in embodiments are not so limited.

A user of device 202 can interact with the number of applications 224-1, 224-2 to send a request to the BMS system and/or to provide BMS information. For example, the user can use an application (e.g., one of applications 224-1) to request a change in a temperature of a room (e.g., related to room comfort control). That is, the user can make a selection on a room control application of the number of applications on the device 202 and the BMS system can adjust a control of the room associated with the location of the user. The user can use an application to request mobile access to the BMS system (e.g., related to mobile access control). The user can use an application to manage a visit to the building location (e.g., related to visitor management). The user can use an application to request information about a location of the building and/or a location of the user (e.g., location based services). The user can use an application to provide building information about the building facility to the BMS system (e.g., related to facility management).

In order to communicate with the BMS system, a user of the device 202 can use an application container 226 to enter user information through an API 228 in communication with the BMS system (e.g., mobile backend service 108 in FIG. 1). For example, an application container 226 can store a number of parameters associated with a user. The user can enter parameter information to be stored in the application container 226 through the device 202. The number of parameters can include identification information of the user, a location of the user, and entitlements of the user. The identification information of the user can include a name, address, email, phone number, etc. The location of the user can include a current location of the user in relation to the building while the user is entering the information. The entitlements of the user can include access rights the user possesses based on the identity and/or location of the user.

For example, a user can have physical access rights to a portion of the building that the user is performing maintenance on, monitoring, etc. A user that is visiting the building can have access rights related to visitor locations in the building. A user can have access rights to a subset of the building. A user can have access rights to use a subset of the applications on the device 102 to control parameters of the building based on the user's access rights and/or which facility the user is located within.

The user can indicate a selection on an application of a number of applications on the device 202 associated with building access. The selection can indicate a request to enter an additional location of the building. The selection can be made by the user using a GUI to interact with the API 228 to send selection information to the BMS front end server 110. When a user is requesting physical access, a virtual key can be sent to the user of the device 202 the made the selection. The virtual key can provide physical access to the additional location for the user using the virtual key.

A mobile backend service (e.g., mobile backend service 108 in FIG. 1) can include an application exchange that controls and manages the number of applications also installed on the device 202. The parameters of the application container 226 can be used to login to and interact with the application exchange on the mobile backend service. In this way, a number of applications 224-1, 224-2 can be used to control a number of systems (e.g., systems 104-1, 104-2, 104-3, 104-4 in FIG. 1) through a central location of an application exchange and by a single credential (e.g., login) and/or authentication system associated with the application container 226.

The application exchange can manage the number of BMS applications by monitoring logins of a number of users. The application exchange can allow access to all of the number of applications for a single login to the application exchange made by each of the logins of the number of users the application exchange is monitoring and/or receiving information from.

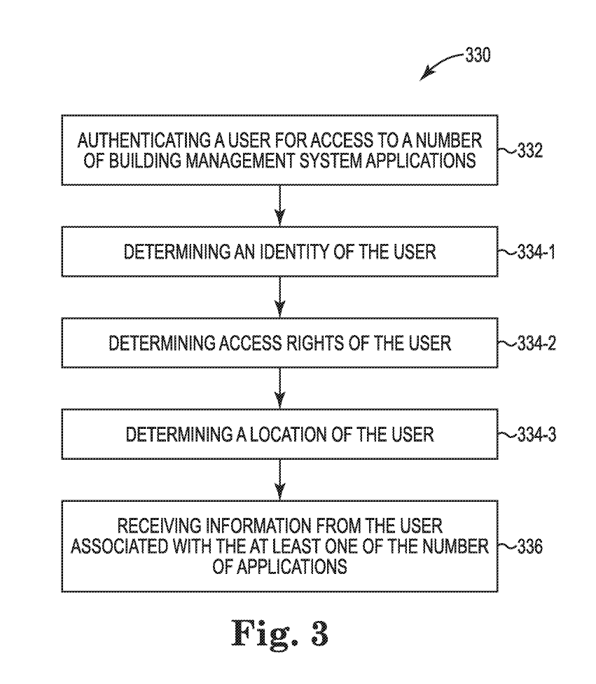

FIG. 3 illustrates an example method 330 for controlling a building management system in accordance with one or more embodiments of the present disclosure. Method 330 can be performed by, for example, BMS front end server 110, device 102, and/or device 202 previously described in connection with FIGS. 1 and 2, respectively.

The method can include, at block 332, authenticating a user for access to a number of building management system (BMS) applications. The authentication can include, at block 334-1, determining an identity of the user. For example, a username and/or password can be used to verify a user's identity.

The authentication can include, at block 334-2, determining access rights of the user. For example, based on how the user is associated with the BMS, the user can be given particular access rights. A user that works at the building can have more access rights than a visitor to the building.

The authentication can include, at block 334-3, determining a location of the user. For example, authenticating a user to enter a particular location can be based on where the user is in relation to the building. In some embodiments, the access rights of the user can change based on the location of the user. For example, an employee can have different access rights based on which building location the employee is at. The employee may work at a first building location and have more access rights and visit a second building location where the employee has fewer access rights.

The method 330 can include, at block 336, receiving information from the user associated with at least one of a number of applications. The received information can include information associated with a number of parameters of the BMS system. The user can be tasked with entering the parameter information at a particular number of intervals of time. The user can enter parameter information based on parameter changes. The user can enter parameter information requesting to change the parameter. The received information can be gathered from a number of users and aggregated to make decisions based on a plurality of data points. The received information can be used for record keeping and further analysis at a later time.

The BMS applications associated with the BMS can be associated with a number of systems of the BMS. At least one application of the BMS applications can be associated with at least one of a security system, a safety system, an energy system, and a Heating Ventilation and Air Conditioning (HVAC) system. The at least one application of the number of BMS applications can be associated with at least one of a room comfort control, a mobile access control, a visitor management, a location based service, and facility management. The at least one application can be associated with location based services and can send a map of a layout of a building to the user to navigate the building.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for controlling a building management system, comprising:
authenticating a user for access to a plurality of building management system (BMS) applications, wherein the authentication comprises:
determining an identity of the user;
determining access rights of the user; and
determining a location of the user;
receiving building data from the user associated with at least one of the number of BMS applications that changes a building parameter; and
changing the building parameter based on the identity, the access rights, and the location of the user and the received building data.

2. The method of claim 1, wherein the access rights of the user can change based on the location of the user.

3. The method of claim 1, wherein:
the received building data includes a selection within an application of the number of applications associated with building access, wherein the selection indicates a request to enter an additional location of the building; and
the method includes sending a virtual key to a physical door of the additional location through the application associated with building access to the authenticated user.

4. The method of claim 1, wherein at least one application of the number of building management system applications is associated with at least one of:
a security system;
a safety system;
an energy system; and
a Heating Ventilation and Air Conditioning (HVAC) system.

5. The method of claim 1, wherein at least one application of the number of building management system applications is associated with at least one of:
room comfort control;
mobile access control;
visitor management;
location based services; and
facility management.

6. The method of claim 5, wherein the at least one application of the number of building management system applications is associated with location based services and is configured to send a map of a layout of a building to the user to navigate the building.

7. A non-transitory computer-readable medium having computer readable instructions stored thereon that are executable by a processor to:
allow a number of users to access a plurality of applications in communication with a building management system (BMS) through an application program interface, wherein the application program interface is in communication with the BMS;
gather BMS data from the number of users based on selections made by the number of users on the number of applications; and
analyze the gathered data, wherein the analysis determines whether a BMS parameter has changed or is being requested by the user to be changed; and
change the BMS parameter based on the analysis.

8. The medium of claim 7, wherein the building management system includes a number of systems associated with at least one of tenants, visitors, safety, energy, environment, building operations, and facility management.

9. The medium of claim 7, wherein the instructions are executable to allow the number of users to access the number of applications through an application exchange using a single login to the application exchange.

10. The medium of claim 9, wherein the single login includes a user identity, a user location, and user rights based on the user's identity and the user's location.

11. The medium of claim 9, wherein the application exchange is a scalable backend system, wherein the scalable backend system changes scale based on the changed parameter.

12. The medium of claim 7, wherein, upon a user of the number of users requesting a change of a parameter associated with a room control application of the number of applications, the instructions are executable to adjust a control of a room associated with the location of the user.

13. The medium of claim 7, wherein the instructions executable to gather the BMS data comprises instructions executable to poll the number of users for a consensus to determine how to change the building parameter.

14. A device for controlling a building management system, comprising:
a memory; and
a processor configured to execute executable instructions stored in the memory to:
install a plurality of building management system (BMS) applications on a number of devices associated with a number of users;
allow the number of users to access, through an application exchange, at least one application of the number of BMS applications through a login to the application exchange;
gather BMS information from a user of the number of users based on at least one selection made by the user on the at least one application; and
change a building parameter of the BMS based on the at least one selection made by the user.

15. The device of claim 14, wherein the number of devices the number of applications are installed on includes at least one of a desktop computer, an internet interface, a phone, a laptop computer, and a digital device.

16. The device of claim 14, wherein the processor is configured to execute the instructions to manage the number of building management system applications by monitoring logins of the number of users and allowing access to all of the number of applications for a single login to the application exchange.

17. The device of claim 14, wherein the login includes information about a user's identity, a user's location, and a user's access rights.

18. The device of claim 17, wherein the user is given access rights to a subset of the number of building management system applications based on the user's access rights.

19. The device of claim 17, wherein the user is given access rights to a subset of the number of building management applications based on which facility the user is located within.

20. The device of claim 14, wherein the device is in communication with at least one of a public network and a private network.
